(19) United States
(12) Patent Application Publication
(10) Pub. No.: US 2021/0249822 A1
(43) Pub. Date: Aug. 12, 2021

(54) CURVED ELECTRICAL CONNECTORS

(71) Applicant: FilConn Inc., Chandler, AZ (US)

(72) Inventors: Mark Pendergrass, Climax, NC (US); Jason Pedruzzi, Wichita, KS (US); David Davis, Gilbert, AZ (US)

(21) Appl. No.: 17/112,336

(22) Filed: Dec. 4, 2020

Related U.S. Application Data
(60) Provisional application No. 62/944,117, filed on Dec. 5, 2019.

(51) Int. Cl. H01R 13/6584; H01R 13/11; H01R 13/502

(52) U.S. Cl. CPC H01R 13/6584; H01R 13/11; H01R 13/64; H01R 2201/26; H01R 13/502

(57) ABSTRACT

A connector system includes a receptacle configured for mounting on a structure having a curved sidewall with an opening formed therein, such as an aerial vehicle having a curved skin with an access opening. The receptacle is configured so that the contacts of the receptacle are accessible from the exterior of the structure, through the opening; and the receptacle does not protrude above the outer surface of the sidewall. The connector system can further include a plug configured to mate with the receptacle to form an electrical connection. The plug can include a retractable shroud that protects the contacts of the plug when the plug is not mated with the receptacle.

### CROSS REFERENCE TO RELATED APPLICATION

The present application claims priority to U.S. provisional Application No. 62/944,117, filed Dec. 5, 2019, the contents of which are incorporated by reference herein in their entirety.

### FIELD

The inventive concepts disclosed herein relate to electrical connectors, such as pin and socket connectors.

### BACKGROUND

Aerial vehicles such as aircraft and missiles often require an electrical connection point that is accessible from the exterior of the vehicle. For example, aerial vehicles may need to be temporarily connected to service equipment, such as diagnostic equipment, while the vehicle is on the ground. The electrical connection point typically is a receptacle. The receptacle is configured to mate with a plug located at the end of a cable leading to the service equipment. While the receptacle needs to be accessible from the exterior of the vehicle, any protrusion of the receptacle above the adjacent surface of the aerial vehicle can cause drag and other undesirable aerodynamic disturbances around the vehicle.

Also, the plug that mates with the receptacle typically has exposed contacts in the form of pins. Because the pins are exposed, the pins are susceptible to physical damage. This can be especially problematic in a maintenance setting where the plug may be mated and de-mated on a repeated basis, often outdoors in less-than-optimal weather and lighting conditions. While a removable cover can offer some protection from such damage when the plug is not in use, such covers often are lost, or are not placed back on the plug by the user after the plug has been de-mated.

### SUMMARY

In one aspect, the disclosed technology relates to a connector system that includes a receptacle configured for mounting on a structure having a curved sidewall with an opening formed therein. The receptacle includes a plurality of electrical contacts, a shell having a curved outer surface, and an electrically-insulating insert mounted at least in part in the shell and having a curved outer surface. The insert has a plurality of bores formed therein and extending inward from the outer surface of the insert. Each of the electrical contacts is positioned at least in part within a respective one of the bores. A portion the insert is elevated in relation to the outer surface of the shell and is configured to fit within the opening in the sidewall.

In another aspect of the disclosed technology, the outer surface of the shell is configured to abut an inner surface of the sidewall when the receptacle is mounted on the structure.

In another aspect of the disclosed technology, the outer surface of the insert is configured to lie approximately flush with an outer surface of the sidewall when the receptacle is mounted on the structure.

In another aspect of the disclosed technology, the outer surface of the shell has a radius of curvature approximately equal to a radius of curvature of the inner surface of the sidewall.

In another aspect of the disclosed technology, the outer surface of the insert has a radius of curvature approximately equal to a radius of curvature of the outer surface of the sidewall.

In another aspect of the disclosed technology, the insert further includes a flange that extends around the outer surface of the insert, and the flange is configured to lie approximately flush with the outer surface of the sidewall when the receptacle is mounted on the structure.

In another aspect of the disclosed technology, the electrical contacts are socket contacts.

In another aspect of the disclosed technology, an entrance to each of the electrical contacts is recessed in relation to the outer surface of the insert.

In another aspect of the disclosed technology, the system further includes a gasket positioned around the flange and configured to contact a periphery of the opening in the sidewall of the structure when the receptacle is mounted on the structure.

In another aspect of the disclosed technology, the gasket is an EMI-shielding gasket.

In another aspect of the disclosed technology, the system further includes a plug configured to mate with the receptacle to establish an electrical connection.

In another aspect of the disclosed technology, the plug includes a plurality of electrical contacts configured to mate with the electrical contacts of the receptacle, a shell, and an electrically-insulating insert mounted at least in part in the shell of the plug and having a curved outer surface. Each of the electrical contacts of the plug is positioned at least in part within the insert of the plug, and the electrical contacts of the plug project from an outer surface of the insert of the plug by substantially the same distance.

In another aspect of the disclosed technology, the electrical contacts of the receptacle are socket contacts and the electrical contacts of the plug are pin contacts.

In another aspect of the disclosed technology, the plug further includes a shroud mounted on the shell of the plug and configured to retract into and extend from the shell of the plug.

In another aspect of the disclosed technology, the shroud is configured to retract into the shell of the plug in response to contact between a forward surface of the shroud and an outer surface of the sidewall as the plug is mated with the receptacle.

In another aspect of the disclosed technology, the forward surface of the shroud is curved and has a radius of curvature approximately equal to a radius of curvature of the outer surface of the sidewall.

In another aspect of the disclosed technology, the shroud is configured to surround the portions of the electrical contacts of the plug that project from the outer surface of the insert of the plug when the shroud is extended from the shell of the plug.

In another aspect of the disclosed technology, the outer surface of the insert of the plug is configured to abut the outer surface of the insert of the receptacle when the plug and the receptacle are mated.

In another aspect of the disclosed technology, the outer surface of the insert of the receptacle is outwardly curved; and the outer surface of the insert of the plug is inwardly curved and has a radius of curvature approximately equal to a radius of curvature of the outer surface of the insert of the receptacle.

In another aspect of the disclosed technology, the sidewall of the structure is a skin of an aerial vehicle, and the receptacle is configured so that the electrical contacts are accessible from an exterior of the aerial vehicle when the receptacle is mounted on the aerial vehicle.

### BRIEF DESCRIPTION OF THE DRAWINGS

Embodiments will be described with reference to the following drawing figures, in which like reference numerals represent like parts and assemblies throughout the several views.

FIG. 1 is a bottom-front perspective view of a receptacle of a curved electrical connector.

FIG. 2 is a side view of the receptacle shown in FIG. 1.

FIG. 3 is a front view of the receptacle shown in FIGS. 1 and 2.

FIG. 4 is a rear view of the receptacle shown in FIGS. 1-3.

FIG. 5 is a side view of a contact of the receptacle shown in FIGS. 1-4.

FIG. 6 is a top view of an opening in the skin, or sidewall of an aerial vehicle on which the receptacle shown in FIGS. 1-5 can be installed.

FIG. 7 is a cross-sectional view of the skin shown in FIG. 6, taken through the line “A-A” of FIG. 6.

FIG. 8 is a side view of a plug configured to mate with the receptacle shown in FIG. 1, showing a shroud of the plug in an extended position.

FIG. 9 is a side view of the plug shown in FIG. 8, showing the shroud in a retracted position.

FIG. 10 is a bottom view of the plug shown in FIGS. 8 and 9, showing the shroud in the extended position.

FIG. 11 is a front view of the plug shown in FIGS. 8-10.

FIG. 12 is a bottom-rear perspective view of the plug shown in FIGS. 8-11, showing the shroud in the extended position.

FIG. 13 is a rear view of the plug shown in FIGS. 8-12, with a rearward portion of a shell of the plug removed.

FIG. 14 is a side view of a contact of the plug shown in FIGS. 8-13.

FIG. 15 is a schematic illustration of the plug and the receptacle shown in FIGS. 1-5 and 8-14, showing the plug and the receptacle in a mated condition in which the plug and the receptacle establish electrical contact between a first and a second electrical component.

### DETAILED DESCRIPTION

The inventive concepts are described with reference to the attached figures. The figures are not drawn to scale and are provided merely to illustrate the instant inventive concepts. The figures do not limit the scope of the present disclosure. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

The figures depict an electrical connector 10. The connector 10 is an electrical connector modeled on the Mil-DTL-24308 series of connectors with customizations. The inventive concepts disclosed herein are described in connection with this particular type of connector for illustrative purposes only; the inventive concepts can be applied to other types of connectors. The connector 10 includes a plug 12; and a socket, or receptacle 14. The plug 12 is configured to mate with the receptacle 14 to establish an electrical connection between a first electrical component 116 in electrical contact with the plug 12; and a second electrical component 118 in electrical contact with the receptacle 14. The first electrical component 116 and the second electrical component 118 are depicted schematically in FIG. 15.

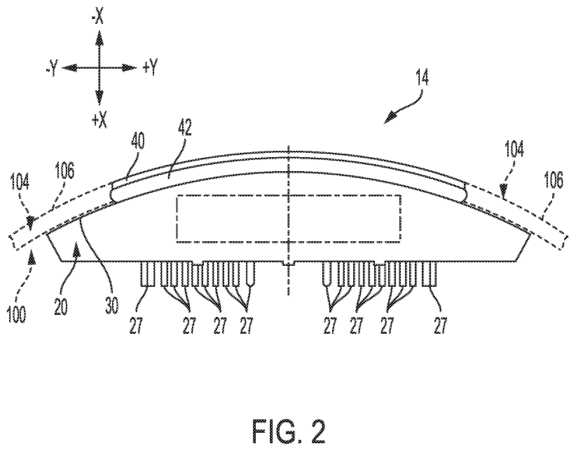

The connector 10 is configured for use on an aerial vehicle 100, a portion of which is depicted in FIGS. 2, 6, and 7. The aerial vehicle 100 can be, for example, a missile. The aerial vehicle 100 includes the second electrical component 118. The aerial vehicle 100 also includes a cylindrical body having an outer sidewall or skin 104. The skin 104 is rounded, giving the body its cylindrical shape. Because the skin 104 forms the outer periphery of the body, an outer surface 106 of the skin 104 is in direct contact with the airflow over the aerial vehicle 100 during flight thereof.

The use of the connector 10 in relation to the aerial vehicle 100 is described for illustrative purposes only. The connector 10 can be used in other vehicle-based, and non-vehicle-based applications.

Receptacle

As can be seen in FIGS. 2, 6, and 7, the receptacle 14 is accessible from the exterior of the aerial vehicle 100 by way of an opening 108 formed in the skin 104. The receptacle 14 is mounted on the vehicle 100 so that the outermost portion of the receptacle 14 is substantially flush with, or slightly recessed in relation to the outer surface 106 of the adjacent portion of the skin 104. The outwardly-facing portion of the receptacle 14 has an outwardly-curved configuration that substantially matches the curvature of the outer surface 102. As a result of this configuration, the receptacle 14 does not protrude above the outer surface 106 of the skin 104, and thus does not protrude into the airflow that passes over the aerial vehicle 100 during flight.

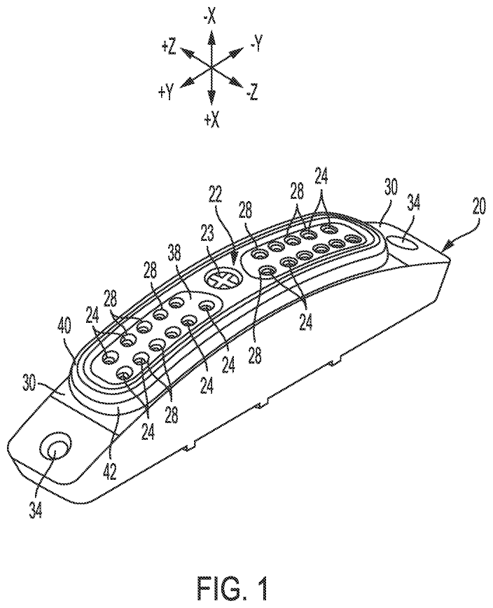

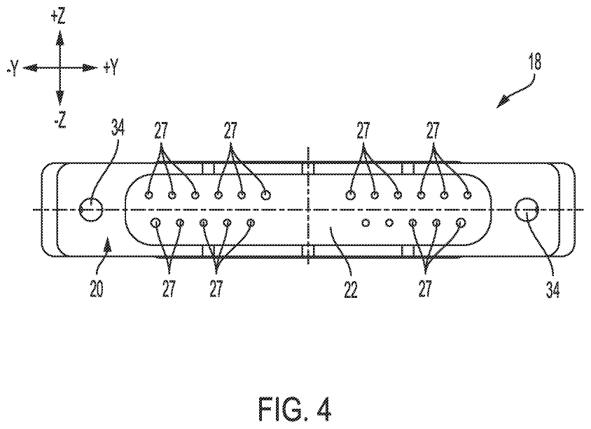

Referring to FIGS. 1-4, the receptacle 14 includes a shell 20, an insert 22, and a plurality of socket contacts 24 mounted in the insert 22. The insert 22 is positioned within the shell 20, and can be retained in the shell 20 by a suitable means such as a fastener 23, and/or epoxy. The insert 22 can be retained by other means, such as an interference fit, in alternative embodiments. The shell 20 can be formed from an aluminum alloy having an electroless nickel—PTFE (Teflon®) coating. The insert 22 can be formed from a high-grade, dielectric thermoplastic material. The shell 20 and the insert 22 can be formed from other materials in the alternative.

The receptacle 14 includes twenty-two of the contacts 24 arranged in two parallel rows, as shown in FIGS. 1, 3, and 4. Alternative embodiments can include more, or less than twenty-two of the contacts 24, arranged in other configurations.

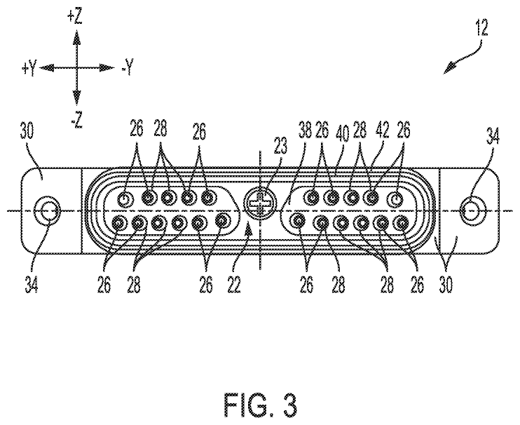

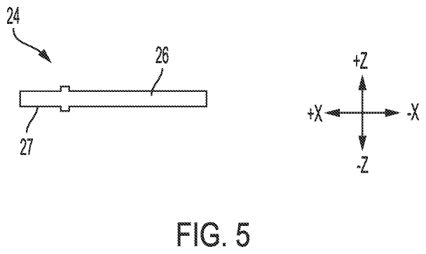

Referring to FIG. 5, each contact 24 has a first portion or socket 26, and a second portion or tail 27 that adjoins the socket 26. The contacts 24 can be formed from a suitable electrically-conductive material such as a nickel/gold-plated copper alloy; the contacts 24 can be formed from other types of materials in the alternative. The socket 26 of each contact 24 is positioned in a corresponding bore 28 formed in the insert 22, so that the open end of the socket 26 faces outward, away from the vehicle 100, i.e., in the “−x” direction; and the tail 27 extends inward, toward the interior of the vehicle 100. The bores 28 are visible in part in FIGS. 1 and 3.

The sockets 26 each receive a corresponding pin contact 50 of the plug 12 when the receptacle 14 and the plug 12 are mated. The contacts 24 can be retained in the insert 22 by a suitable means such as an interference fit between the sockets 26 and the insert 22. The contacts 24 can be retained by other means, such as adhesive, in the alternative.

The tail 27 of each contact 24 is electrically and mechanically connected to a first end of a respective wire lead 110. The wire leads 110 are depicted schematically in FIG. 15. The tail 27 and its corresponding wire lead 110 can be connected by a suitable means such as crimping. A second end of each wire lead 110 is electrically and mechanically connected to the second electrical component 118, so that the wire leads 110 place the receptacle 14 in electrical contact with the second electrical component 118. Four of the contacts 24 can be configured as 20 AWG contacts, and eighteen of the contacts 24 can be configured as 22 AWG contacts. This particular configuration for the contacts 24 is presented for illustrative purposes only. The contacts 24 can be configured with other wire gauges in alternative embodiments.

The shell 20 has an outer surface 30, as can be seen in FIGS. 1 and 3. The outer surface 30 faces outward, away from the vehicle 100, i.e., in the “−x” direction, when the receptacle 14 is mounted on the vehicle 100. The outer surface 30 has a curvature that approximately matches the curvature of the skin 104 of the aerial vehicle 100. In particular, the surface 30 has a radius of curvature that substantially matches the radius of curvature of the skin 104.

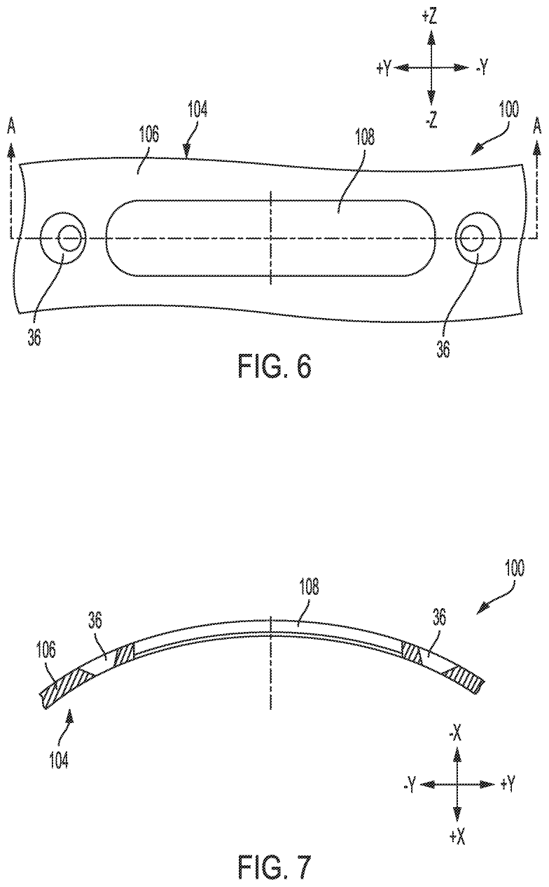

The shell 20 has an opening (not visible in the figures) that extends inwardly from the outer surface 30, and receives the insert 22. Also, the shell 20 has two threaded bores 34 formed therein, proximate opposite ends of the shell 20, as shown in FIGS. 1, 3, and 4. The bores 34 extend inwardly from the outer surface 30. The bores 34 receive fasteners (not shown) that extend through corresponding openings 36 in the skin 104 of the vehicle 100, and secure the receptacle 14 to the skin 104. The openings 36 are shown in FIGS. 6 and 7.

The insert 22 has an outer surface 38, as can be seen in FIGS. 1 and 3. The outer surface 38 faces outward, away from the vehicle 100, when the receptacle 14 is mounted on the vehicle 100. The outer surface 38, like the outer surface 30 of the shell 20, has a radius of curvature that is approximately equal to the radius of curvature of the skin 104 of the aerial vehicle 100. The bores 28 that accommodate the sockets 26 of the contacts 24 extend inward from the outer surface 38.

The insert 22 has a lip, or flange 40 formed thereon. The flange 40 is visible in FIGS. 1, 2, and 3. The flange 40 adjoins the outer surface 38, and extends along the periphery of the outer surface 38. The flange 40 forms the outermost portion of the receptacle 14 when the receptacle 14 mounted on the aerial vehicle 100, i.e., the flange 40 is the portion of the receptacle 14 located closest to the exterior of the vehicle 100. The flange 40 has a curvature that substantially matches the curvature of the skin 104.

The opening 108 in the skin 104 has a shape and dimensions that substantially match the shape and dimensions of the outer perimeter of the flange 40. The flange 40 and the outer surface 38 are raised, or elevated in relation to the outer surface 30 of the shell 20, from the perspective of FIG. 2, so that the flange 40, the outer surface 30, and the adjacent portion of the insert 22 reside within the opening 108 in which the receptacle 14 is mounted on the aerial vehicle 100. The insert 22 is configured so that the outwardly-facing side of the flange 40 remains flush with, or below the adjacent portion of the outer surface 106 of the skin 104, from the perspective of FIG. 2. As a result of the curved configurations of the flange 40 and the outer surface 38 of the insert 22, the flange 40 and the outer surface 38 follow the contour of the skin 104, and remain at substantially constant depths in relation of the outer surface 106. Thus, no part of the receptacle 14 protrudes into the airflow around the aerial vehicle 100 during flight; the respective outer ends of the sockets 26 of the contacts 24 are recessed in relation to the adjacent portion of the outer surface 106 by substantially the same amount; and the insertion depth of the plug contacts 50 into the sockets 26 is the same for all of the sockets 26.

The receptacle 14 thus provides a ready access point for establishing electrical contact with electrical components located within the aerial vehicle 100. The receptacle 14 can be accessed easily, without a need to disassemble or remove any parts of the vehicle 100, and the insertion depth of the pin contacts 50 into the corresponding sockets 26 of the receptacle 14 is uniform. At the same time, the receptacle 14 introduces little or no aerodynamic drag to the vehicle 100 during flight, because the receptacle 14 does not protrude above the outer surface 106 of the outer skin 104.

An EMI-shielding gasket 42 is positioned around the portion of the insert 22 that projects above the surface 30, as can be seen in FIGS. 1 and 2. The gasket 42 is retained on the insert 22 by the flange 40. The gasket 40 helps to seal the interface between the receptacle 14 and the outer skin 104 of the aerial vehicle 100, and helps to isolate the interior of the aerial vehicle 100 from externally-generated electromagnetic interference (EMI).

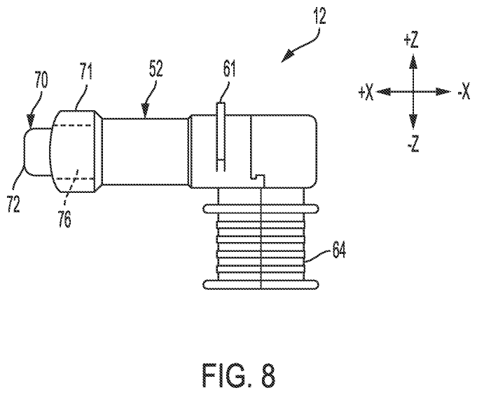

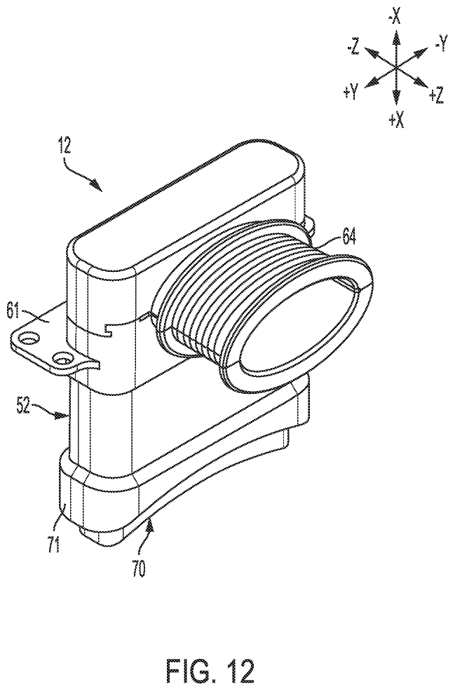

Plug Referring to FIGS. 8-13, the plug 12 includes a shell 52, an insert 54, and a plurality of the pin contacts 50 mounted in the insert 54. The insert 54 is positioned within the shell 52, and can be retained in the shell 52 by an epoxy compound. The insert 54 can be retained by other means, such as an interference fit, in alternative embodiments. The shell 52 can be formed from an aluminum alloy having an electroless nickel—PTFE (Teflon®) coating. The insert 54 can be formed from a high-grade, dielectric thermoplastic material. The shell 52 and the insert 54 can be formed from other materials in the alternative.

The plug 12 includes twenty-two of the pin contacts 50 arranged in two parallel rows so as to facilitate the mating of each contact 50 with a corresponding one of the contacts 24 of the receptacle 14. Alternative embodiments can include more, or less than twenty-two of the contacts 50, arranged in other configurations, to match the number and configuration of the contacts 24.

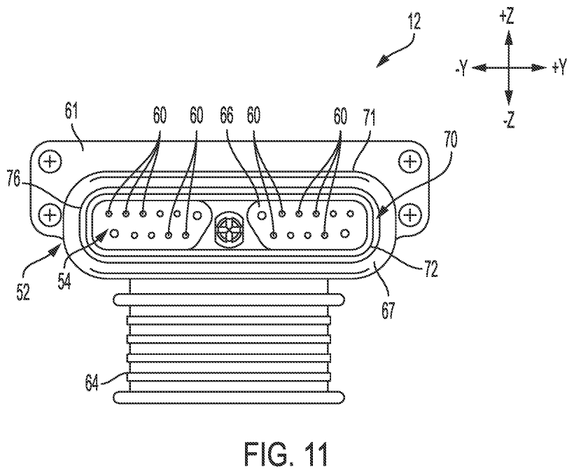

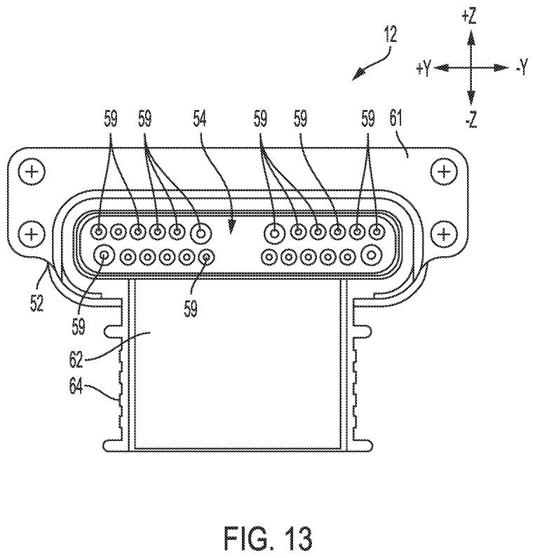

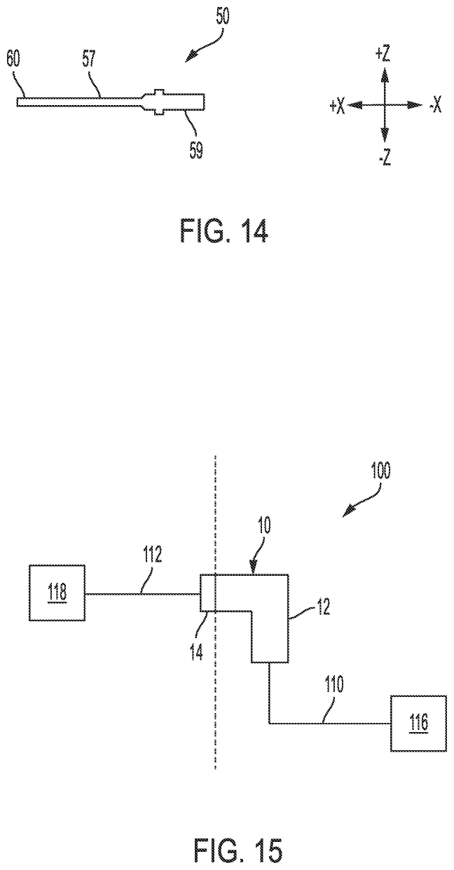

The pin contacts 50 can be formed from a suitable electrically-conductive material such as nickel-plated aluminum alloy; the contacts 50 can be formed from other types of materials in the alternative. A middle portion 57 of each contact 50 is positioned in a corresponding bore (not shown) formed in the insert 54, so that an adjoining mating portion 60 of the contact 50 extends or projects from the insert 54 in a forward, or mating direction of the plug 12. The mating direction of the plug 12 is denoted in the figures as the “+x” direction. The middle portion 57 of the contacts 50 is depicted in FIG. 14. The mating portion 60 can be seen in FIGS. 11 and 13.

The mating portion 60 of each contact 50 is received by the socket 26 of a corresponding one of the contacts 24 of the receptacle 14 when the plug 12 and the receptacle 14 are mated. The contacts 50 can be retained in the insert 54 by a suitable means such as an interference fit between the middle portions 57 of contacts 50 and the insert 54. The contacts 50 can be retained by other means, such as adhesive, in the alternative.

Referring to FIGS. 13 and 14, each contact 50 also has a tail 59 that adjoins the middle portion 57 of the contact 50. FIG. 13 depicts the plug 12 with a rearward portion of the shell 52 removed, so that the tails 59 are visible. The tails 59 extend from a rearward side of the insert 54, and are located within the shell 52. Each tail 59 is electrically and mechanically connected to a first end of a respective wire lead 112, as depicted schematically in FIG. 15. The tail 59 and its corresponding wire lead 112 can be connected by a suitable means such as crimping. A second end of each wire lead 112 is electrically and mechanically connected to the first electrical component 116, so that the wire leads 112 place the plug 12 in electrical contact with the first electrical component 116.

Four of the contacts 50 can be configured as 20 AWG contacts, and eighteen of the contacts 50 can be configured as 22 AWG contacts. This particular configuration for the contacts 50 is presented for illustrative purposes only. The contacts 50 can be configured with other wire gauges in alternative embodiments.

The shell 52 incudes a flange 61, shown in FIGS. 8-13. The flange 61 provides a means for temporarily securing the plug 12 to the aerial vehicle 100 using fasteners, after the plug 12 has been mated with the receptacle 14. The specific configuration of the flange 61 is dependent upon the geometry of the aerial vehicle 100 or other structure on which the receptacle 14 is installed. The configuration of the flange 61, therefore, can vary from that disclosed herein in alternative embodiments. Other alternative embodiments can forgo the use of the flange 61 altogether.

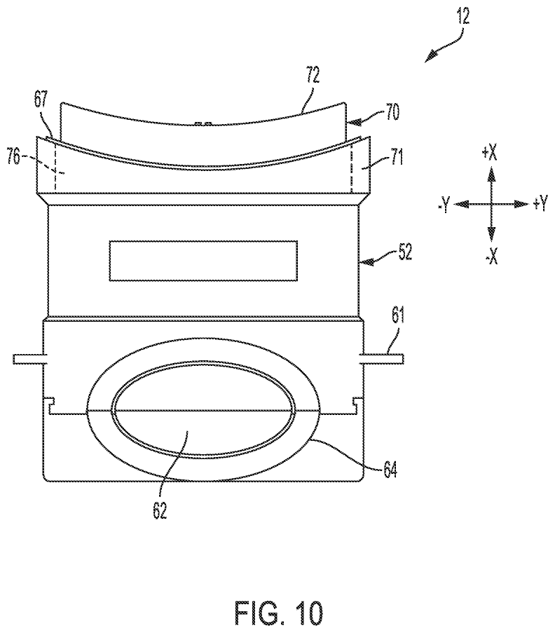

The shell 52 has an opening 62 formed proximate a rearward end thereof, as shown in FIG. 10. The plug 12 further includes a shroud 64. The shroud 64 is attached to the exterior of the shell 52 so that an interior volume of the shroud 64 aligns with the opening 62. The wire leads 112 connected to the plug 12 exit the shell 52 by way of the opening 62, in a direction substantially perpendicular to the mating direction of the plug 12, i.e., in the “−z” direction.

Referring to FIG. 11, the insert 54 has an outer surface 66. The outer surface 66 has an inwardly-curved configuration. The outer surface 66 has a radius of curvature that substantially matches the radius of curvature of the outwardly-curved outer surface 38 of the receptacle 14. The outer surface 66 abuts, and conforms to the outer surface 38 when the plug 12 is fully mated with the receptacle 14.

The mating portions 60 of the pin contacts 50 project from the outer surface 66 by a substantially common distance, i.e., the respective heights of the mating portions 60 above the outer surface 66 are approximately equal. Due to the matching curvatures of the outer surface 66 and the outer surface 38 of the receptacle 12, the respective mating portions 60 enter the sockets 26 of their corresponding receptacle contacts 24 at about the same point, and slide into the sockets 26 by approximately the same distance, as the plug 12 and the receptacle 14 are mated; and the outer surface 66 abuts and conforms to the outer surface 38 when the plug 12 and the receptacle 14 have been fully mated.

The shell 52 of the plug 12 has an outer surface 67, shown in FIGS. 10 and 11. The outer surface 67 has an inwardly-curved configuration, as can be seen in FIG. 10. The radius of curvature of the outer surface 67 substantially matches the radius of curvature of the outwardly-curved skin 104 of the aerial vehicle 100. The outer surface 67 abuts the skin 104, adjacent the opening 108, when the plug 12 is mated with the receptacle 14.

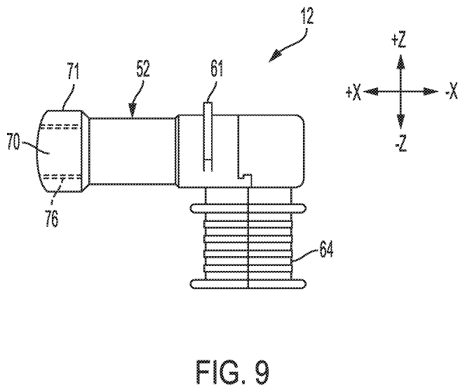

The plug 12 further comprises a retractable shroud 70. The shroud 70 is positioned on a forward portion 71 of the shell 52. The shroud 70 is movable in relation to the shell 52, between a first, or extended position shown in FIGS. 8 and 10-12; and a second, or retracted position shown in FIG. 9. The shroud 70 can retract into a cavity 76 formed within the forward portion 71 of the shell 52 as the shroud 70 moves toward its retracted position. The cavity 76 is located proximate the outer perimeter of the shell 52, and has a shape that approximately matches the profile of the shroud 70 when viewed from the “+x” direction. The cavity 76 is depicted in phantom in FIGS. 8-10; and the outline of the cavity 76, from a front perspective, can be seen in FIG. 11. The shroud 70 is biased toward its extended position by springs (not shown) located within the cavity 76.

The shroud 70 has a forward surface 72 that faces the mating, or “+x,” direction. The forward surface 72 has an inward curvature that approximately matches the outward curvature of the skin 104 of the aerial vehicle 100, as shown in FIGS. 9 and 10.

As can be seen in FIGS. 8 and 10-12, the shroud 70, when in the extended position, surrounds, and prevents unwanted contact with the mating portions 60 of the contacts 50 on four sides, while permitting external access to the mating portions 60 from the front of the plug 12, i.e., from the mating direction. The forward surface 72 is approximately co-extensive with, i.e., occupies the same “x” axis positions, as the respective tips or outer ends of the mating portions 60 of the contacts 50, when the shroud 70 is in its extended position. As discussed below, the shroud 70 resides in its extended position when the plug 12 is not mated with receptacle 14. The shroud 70 thus surrounds, shields, and protects the mating portions 60 from being bent, crushed, cut or otherwise damaged when the plug 12 is being stored or transported, or otherwise is in an un-mated state.

To mate the plug 12 and the receptacle 14, the user manually aligns the plug 12 with the receptacle 14 so that the mating portion 60 of each contact 50 on the plug 12 is approximately aligned with the socket 26 of the corresponding contact 24 on the receptacle 14. The plug 12 is then moved toward the receptacle 14, causing the forward surface 72 of the shroud 70 to contact the outer surface 106 of the skin 104 of the aerial vehicle 100. Further movement of the plug 12 toward the receptacle 14 brings the ends of the contact portions 60 into contact with their associated sockets 26, and causes the shroud 70 to begin retracting into the cavity 76, against the bias of the springs located within the cavity 76. As the user continues to urge the plug 12 toward the receptacle 14, the mating portions 60 extend further into their corresponding sockets 26, and the shroud 70 continues to retract into the cavity 76. When the plug 12 eventually reaches its fully mated position, each contact portion 60 is fully inserted in its corresponding socket 26, thereby establishing an electrical connection between the first electrical component 116 and the second electrical component 118; the shroud 70 resides in its retracted position within the shell 20; and the outer surface 66 of the insert 54 of the plug 12 abuts the outer surface 38 of the receptacle 14.

The plug 12 is de-mated from the receptacle 14 by manually exerting force on the plug 12 in the “−x” direction. As the plug 12 moves away from the receptacle 14, the contact portions 60 of the contacts 50 move out of their corresponding sockets 26, and the shroud 70 returns to its extended position under the bias of the springs located within the cavity 76. As noted above, the shroud 70, when extended, forms a physical barrier around the contact portions 60 that can protect the contact portions 60 from physical damage when the plug 12 is in a de-mated state.

In alternative embodiments, the receptacle 14 can equipped with the pin contacts 50, and the plug 12 can be equipped with the socket contacts 24.

The term “approximately,” when used in connection with a numeric value, is intended to include values that are close to, but not exactly, the number. For example, in some embodiments, the term “approximately” may include values that are within +/−ten percent of the value.

What is claimed is:

1. A connector system comprising a receptacle configured for mounting on a structure having a curved sidewall with an opening formed therein, the receptacle comprising:
a plurality of electrical contacts;
a shell having a curved outer surface; and
an electrically-insulating insert mounted at least in part in the shell and having a curved outer surface, wherein: the insert has a plurality of bores formed therein and extending inward from the outer surface of the insert; each of the electrical contacts is positioned at least in part within a respective one of the bores; and a portion the insert is elevated in relation to the outer surface of the shell and is configured to fit within the opening in the sidewall.

2. The system of claim 1, wherein the outer surface of the shell is configured to abut an inner surface of the sidewall when the receptacle is mounted on the structure.

3. The system of claim 2, wherein the outer surface of the insert is configured to lie approximately flush with an outer surface of the sidewall when the receptacle is mounted on the structure.

4. The system of claim 2, wherein the outer surface of the shell has a radius of curvature approximately equal to a radius of curvature of the inner surface of the sidewall.

5. The system of claim 3, wherein the outer surface of the insert has a radius of curvature approximately equal to a radius of curvature of the outer surface of the sidewall.

6. The system of claim 3, wherein the insert further comprises a flange that extends around the outer surface of the insert, and the flange is configured to lie approximately flush with the outer surface of the sidewall when the receptacle is mounted on the structure.

7. The system of claim 1, wherein the electrical contacts are socket contacts.

8. The system of claim 7, wherein an entrance to each of the electrical contacts is recessed in relation to the outer surface of the insert.

9. The system of claim 6, further comprising a gasket positioned around the flange and configured to contact a periphery of the opening in the sidewall of the structure when the receptacle is mounted on the structure.

10. The system of claim 9, wherein the gasket is an EMI-shielding gasket.

11. The system of claim 1, further comprising a plug configured to mate with the receptacle to establish an electrical connection.

12. The system of claim 11, wherein the plug comprises:
a plurality of electrical contacts configured to mate with the electrical contacts of the receptacle;
a shell; and
an electrically-insulating insert mounted at least in part in the shell of the plug and having a curved outer surface, wherein each of the electrical contacts of the plug is positioned at least in part within the insert of the plug, and the electrical contacts of the plug project from an outer surface of the insert of the plug by substantially the same distance.

13. The system of claim 12, wherein the electrical contacts of the receptacle are socket contacts and the electrical contacts of the plug are pin contacts.

14. The system of claim 12, wherein the plug further comprises a shroud mounted on the shell of the plug and configured to retract into and extend from the shell of the plug.

15. The system of claim 14, wherein the shroud is configured to retract into the shell of the plug in response to contact between a forward surface of the shroud and an outer surface of the sidewall as the plug is mated with the receptacle.

16. The system of claim 15, wherein the forward surface of the shroud is curved and has a radius of curvature approximately equal to a radius of curvature of the outer surface of the sidewall.

17. The system of claim 14, wherein the shroud is configured to surround the portions of the electrical contacts of the plug that project from the outer surface of the insert of the plug when the shroud is extended from the shell of the plug.

18. The system of claim 12, wherein the outer surface of the insert of the plug is configured to abut the outer surface of the insert of the receptacle when the plug and the receptacle are mated.

19. The system of claim 18, wherein the outer surface of the insert of the receptacle is outwardly curved; and the outer surface of the insert of the plug is inwardly curved and has a radius of curvature approximately equal to a radius of curvature of the outer surface of the insert of the receptacle.

20. The system of claim 1, wherein the sidewall of the structure is a skin of an aerial vehicle, and the receptacle is configured so that the electrical contacts are accessible from an exterior of the aerial vehicle when the receptacle is mounted on the aerial vehicle.
